(19) United States
(12) Patent Application Publication
(10) Pub. No.: US 2003/0036381 A1
(43) Pub. Date: Feb. 20, 2003

(54) Wireless communication system with data changing/updating function

(75) Inventor: Noriaki Nagashima, Shizuoka (JP)

Correspondence Address: McGinn & Gibb, PLLC, Suite 200, 8321 Old Courthouse Road, Vienna, VA, 22182-3817, US

(73) Assignee: NEC Corporation, Tokyo (JP)

(21) Appl. No.: 10/218,602

(22) Filed: Aug. 15, 2002

(30) Foreign Application Priority Data
Aug. 16, 2001 (JP) 246867/2001

(51) Int. Cl. H04Q 7/20

(52) U.S. Cl. 455/420; 455/517

(57) ABSTRACT

A transmitting/receiving part 240 connected to a controller 200 for compositely controlling a master communication unit 101 as a whole, receives transmitted signals from a number of slave communication units, and also transmits signals to the slave communication units. Received data obtained in the transmitting/receiving part 240 is dealed with as communication signal, which is provisionally stored in a signal buffer 250 and subjected to suitable signal processing in the signal processing part 220 to be coupled as received data to the controller 200. As data from the controller 200 is subjected to adequate signal processing in the signal processing part 220, data transmitted from the transmitting/receiving part 240 is made to be communication signal 230, which is converted for transmission in the transmitting/receiving unit 240 and transmitted via an antenna 260 to a number of slave communication units.

### BACKGROUND OF THE INVENTION

This application claims benefit of Japanese Patent Application No. 2001-246867 filed on Aug. 16, 2001, the contents of which are incorporated by the reference.

The present invention relates to a wireless communication system with data changing/updating function capable of voice, data, etc. communication using radio wave, light, etc., medium among a plurality of communication terminal units.

As usual, there is a case that it is desired to change or update the contents of accumulated programs provided in a communication terminal unit used in a radio communication system having been in duty service, for instance mobile terminal unit or a subscribed terminal unit connected to a telephone set, or in a terminal unit used in a telemetering system. Also, there is a case of partly changing or updating data provided in a terminal unit.

In these cases, a service department may cover all the communication terminal units and replace stored program data and other data by replacing a memory element mounted on a circuit board in each unit and/or changing ROM and RAM data. This operation is extremely ineffective. Accordingly, it is made possible to change the stored program data and other data under remote control.

FIG. 5 shows a specific example of mobile terminal unit in case where the communication terminal unit is a PHS telephone system. As shown, the unit comprises a controller 500 for compositely controlling its entirety. A display 510 and a key operating part 511 are connected to the controller 500. According to the key input data from the key operating part 511, the controller 500 can provide various operation commands and also cause contents of display of operation mode, calling side telephone number, call transmission history, call reception history and telephone diary on the display 510.

A transmitting/receiving part 540 connected to the controller 500 has a function of data transmission via an antenna 560 to a large number of mobile terminal units. More specifically, the unit 540 can obtain the received data by receiving transmitted signal from other communication units and can also transmit transmission data to the other communication units.

The received data obtained in the transmitting/receiving unit 540, which is dealt with as communication signal 530, is provisionally stored as desired in a signal buffer 550, and it is converted to a composite signal or subjected to adequate signal processing in a signal processing part 520 to be inputted as received data to the controller 500. As for the transmission data to be transmitted from the transmitting/receiving part 540, the signal processing part 520 executes coding or adequate signal processing of data from the controller 200 to provide communication signal 530, which is subjected to conversion for transmission in the transmitting/receiving part 540 and then transmitted via the antenna 560 to other communication units.

Furthermore, the controller 500 is provided with a re-writing interface 570, which is exclusive for the open unit and not versatile for the other unit, and the user goes to the place of installation of the terminal unit for program transfer from an exclusive transfer unit via the re-writing interface 570. Alternatively, the user goes to the place of installation of any other terminal unit for replacing a storing means (such as a ROM or a RAM) of the unit with a ROM, in which a program for changing and/or updating the contents of the storing means is stored.

The above unit which requires changing and/or updating of accumulated programs or data, of course has a means for storing programs or the like in a storing medium capable of re-writing. As for the re-writing means and procedure, an exclusive re-writing interface 70 is provided for separately transferring new contents separately stored in a particular medium by using an additional unit.

In the prior art radio communication system with data changing/updating function, for changing and/or updating accumulated programs and the like in each terminal unit, it is necessary to provide particular additional interface and additional unit. This means that when changing and/or updating programs or the like in a very large number of units, one has to select either parallel operation by preparing a large quantity of special additional units or operation taking enormous time. That is, limitation is imposed by the operation of additional units, or enormous time and cost are necessary.

Furthermore, while the prior art system requires exclusive units or built-in means, the necessity of storing data in separate medium leads not only to hazardous possibility of content errors but also to considerable time in case of transfer to a number of objects.

### SUMMARY OF THE INVENTION

An object of the present invention is to provide a wireless communication system with data changing/updating function”, which does not require any exclusive additional unit or re-writing interface and permits efficient changing and/or updating of programs or accumulated data without requiring substantial man-hour and cost even where a number of terminal units are connected to it.

According to an aspect of the present invention, there is provided a wireless communication system with data changing/updating function for mutual communication of voice, data, etc. among a plurality of mobile terminal units by using radio waves, light or like medium, wherein: the plurality of mobile terminal units each includes a storing means for storing data concerning the control of the own unit, a transmitting means for reading out data stored in the storing means and transmitting the read-out data to an other unit, a receiving means for receiving control data transmitted from the other unit, and a re-writing means for changing and/or updating control data stored in the storing means in the own unit on the basis of control data received by the receiving means.

According to another aspect of the present invention, there is provided a wireless communication system with data changing/updating function for mutual communication of voice, data, etc. among a plurality of mobile terminal units by using radio waves, light or like medium, wherein: a selected unit among the plurality of mobile terminal units includes a storing means for storing data for control of the own unit, and a transmitting means for reading out data stored in the storing means and transmitting the read-out data to an other unity; and a selected unit among the plurality of mobile terminal units includes a storing means for storing data concerning control of the own unit, a receiving means for receiving control data transmitted from the other unit, and a re-writing means changing and/or updating control data stored in the storing means in the own unit on the basis of control data received by the receiving means.

According to other aspect of the present invention, there is provided a wireless communication system with data changing/updating function for mutual communication of voice, data, etc. among a plurality of communication terminal units each provided with an additional wireless communication unit by using radio waves, light or like medium, wherein: the plurality of communication terminal units each includes a storing means for storing data concerning control of the own unit, a transmitting means for reading out data stored in the storing means and transmitting the read-out data to an other unit, a receiving means for receiving control data transmitted from the other unit, and a re-writing means for changing and/or updating control data stored in the storing means in the own unit on the basis of control data received by the receiving means.

According to further aspect of the present invention, there is provided a wireless communication system with data changing and/or updating function for mutual communication of voice, data, etc. among a plurality of communication terminal units each provided with an additional wireless communication unit by using radio waves, light or like medium, wherein: a selected unit among the plurality of communication terminal units includes a storing means for storing data for control of the own unit, and a transmitting means for reading out data stored in the storing means and transmitting the read-out data to the other unit; and a selected unit among the plurality of communication terminal units includes a storing means for storing data for control of the own unit, a receiving means for receiving control data transmitted from the other unit, and a re-writing means for changing and/or updating control data stored in the storing means in the own unit.

At the time of a call signal transmission from a given unit among the plurality of mobile terminal units or the communication terminal units to the plurality of other units, the number of other units with reply signals received therefrom, and when the detected number is identical with the number of transmitted calls, the transmission interval time of the plurality of other units is determined on the basis of the detected number, while determining it according to a predetermined number in the case of failure of detection of any transmitted call number.

The storing means stores a program to be executed by the own unit, version data of programs to be executed by the own unit, communication history data of the own unit, calling history data of the own unit and called history data.

Other objects and features will be clarified from the following description with reference to attached drawings.

### BRIEF DESCRIPTION OF THE DRAWINGS

FIG. 1 shows a schematic circuit construction of the master communication unit in a wireless communication system with data changing/updating function according to an embodiment of the present invention;

FIG. 2 shows a schematic view of the slave communication unit for mutual communication with the master communication unit shown in FIG. 1;

FIG. 3 shows a sequence diagram for explaining the mutual communication operation of the wireless communication system with data changing/updating function shown in FIGS. 1 and 2;

FIG. 4 shows a schematic circuit construction of the master communication unit in a wireless communication system with data changing/updating function according to another embodiment of the present invention; and

FIG. 5 shows a specific example of mobile terminal unit in case where the communication terminal unit is a PHS telephone system.

### PREFERRED EMBODIMENTS OF THE INVENTION

Preferred embodiments of the present invention will now be described with reference to the drawings.

In the following embodiments, although the term “radio” is used, “light” or other communication medium may also be used for indicating “wireless”.

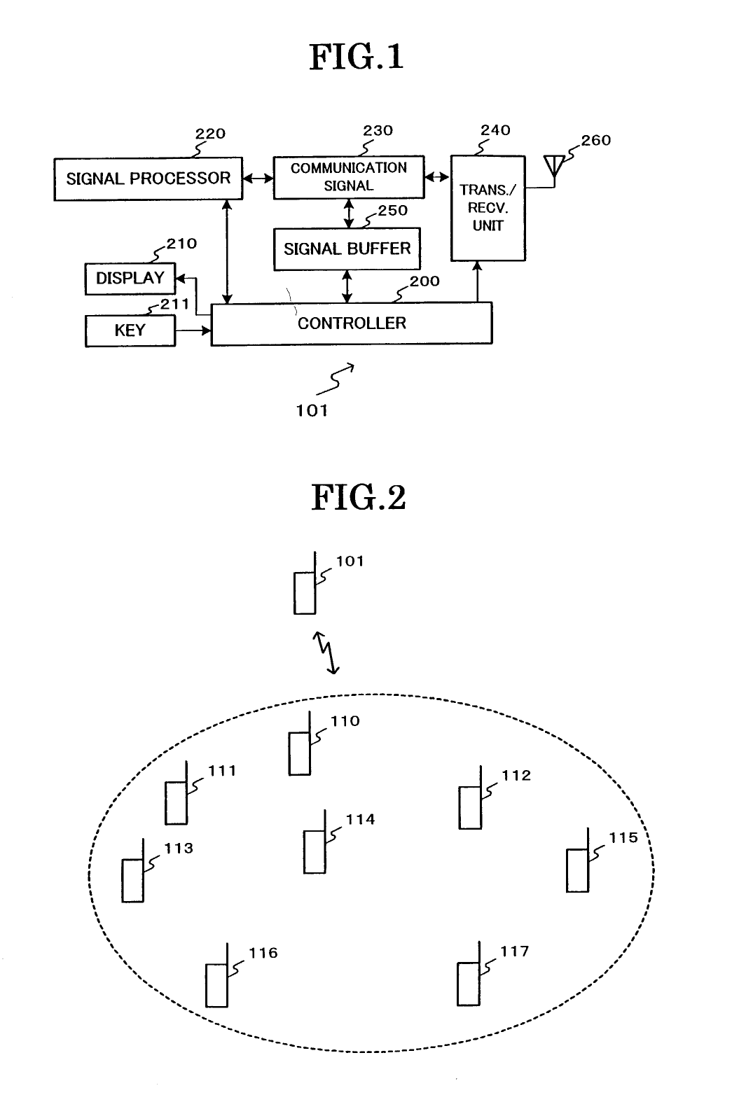

A first embodiment of the present invention will now be described with reference to FIGS. 1 to 3. This embodiment is an application of the present invention to the case where a radio (wireless) communication system constituted by a master communication unit and a plurality of slave communication units is a PHS telephone system. The master communication unit is a program transfer source, and the slave communication units are each a program transfer destination. Both kinds of units are PHS telephone terminal units.

The block diagram of FIG. 1 shows a schematic circuit construction of the mater communication unit. As shown, the master communication unit 101 has a controller 200 for composite control of it as a whole. A display 210 and a key operation part 211 are connected to the controller 200. The controller 200 can provide various operation command and also cause display of such contents as operation mode, calling side telephone number, calling side history, called side history, telephone diary on the display 210.

A transmitting/receiving part 240 connected to the controller 200 receives via an antenna 260 as received data transmitted signals from a large number of slave communication terminals 111 to 117 (see FIG. 2).

The received data obtained in the transmitting/receiving part 240, which is dealt with as communication signal 230, is provisionally stored as desired in a signal buffer 250 and subjected to coding or adequate signal processing in a signal processing part 220 to be inputted as received data to the controller 200. As for transmission data to be transmitted from the transmitting/receiving part 240, the signal processing part 220 executes coding or adequate signal processing of data from the controller 200 to provide communication signal 230, which is subjected to conversion for transfer in the transmitting/receiving unit 240 and then transmitted via the antenna 260 to a number of slave communication units 110 to 117.

Thus, in a radio (wireless) communication system, which permits communication of voice, data, etc. between a fixed station and a plurality of mobile terminal units by using such medium as radio wave or light and also permits mutual communication among the plurality of mobile terminal units alone, a wireless communication system with data changing/updating system is constituted by providing, in each of the plurality of mobile terminal units, a storing means for storing data concerning the control of the own unit, a receiving means for receiving data concerning the control of data transmitted from other units, and a re-writing means for changing and/or updating data concerning the control of data stored in the storing means of the own unit on the basis of the data concerning the control of data received in the receiving means.

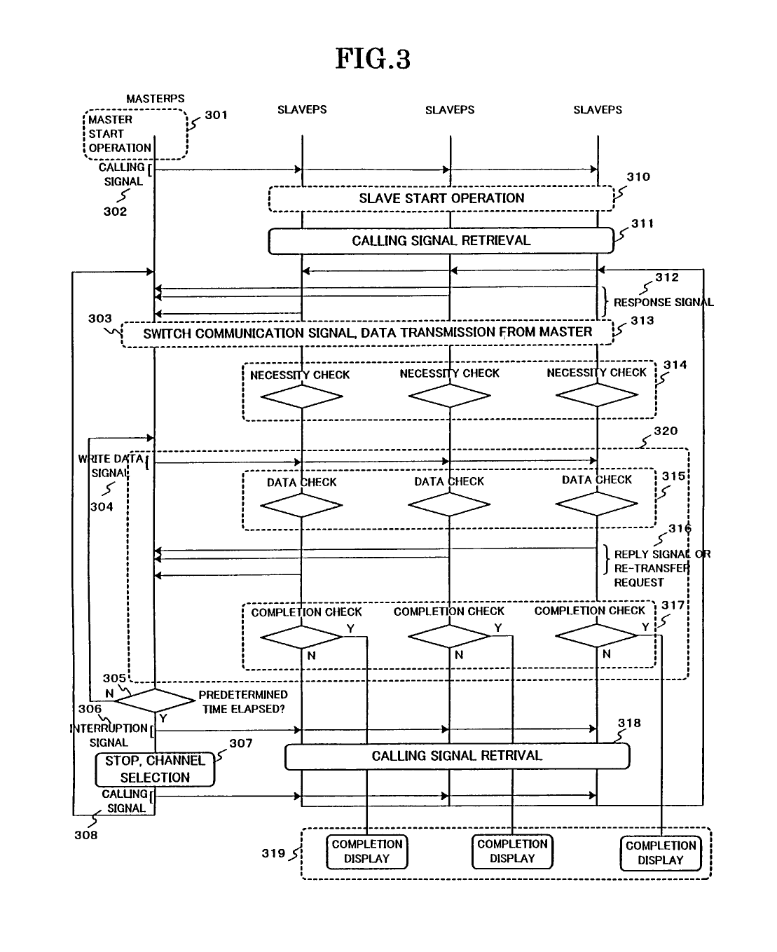

The operation of changing program data in the slave communication units 110 to 117 under control of a command from the master communication unit 101 will be described with reference to the sequence diagram shown in FIG. 3. The master communication units 101 is referred to as “master PS”, and the slave communication units 110 to 117 are referred to as “slave PS”. In the sequence diagram shown in FIG. 3, by the term “master PS” is meant a unit which holds contents to be changed and/or updated, and by the term “slave PS” is meant a unit as subject of changing and/or updating. In the sequence diagram, three slave PSs are shown, but it is of course possible that seven slave PSs as shown in FIG. 2 or any other number of slave PSs are involved.

When remote control program transfer is started by operation of the key operating part 211 in the master PS (step 301), a next step 302 is executed, in which a continuous call signal for the calling of the three slave PSs from the master PS is transmitted from the transmitting/receiving part 240 of the master PS via the antenna 260.

The start may be commanded by causing display on the display 210 or operating the key operating part 211. As an alternative method, although not shown, the start may be commanded by providing special call arrival including transfer start data. In the case of a unit without any operating part such as a data communication PC card, the start may be realized by providing a similar command from an external unit. This method may be implemented by selecting a plurality or either one of these functions.

The slave PSs each having received such call signal, each execute a step 310 of slave start operation, and then go to a step 311. In the step 311, each slave PS having received the command of the “remote control program transfer” retrieves the call signal from the master PS, and causes establishment of synchronization of radio sections.

In a step 312, each step PS having detected the call signal from the master PS returns a reply to the master PS.

Subsequently, steps 303 and 313 are executed, in which the call/reply phase between the master PS and the slave PSs is completed to proceed to a communication phase, and data transmission from the master PS is started.

Indirect communication between PSs of PHS telephone system standards (RCRSTD-28), which are standards for one-to-one communication, the replay signals in the step 312 are transmitted continuously until phase switching to the communication phase. Also the master PS switches the phase to the communication phase as soon as it receives replay signal. In this embodiment, however, the master PS should communicate with a plurality of slave PSs at a time, the replay signals in the step 312 are not transmitted continuously but are transmitted intermittently. Also, the master PS, even having received reply signal, does not go to the next step 303 but continuously transmits the call signal for a predetermined period of time.

In a step 314 which is a next step to the step 313, each slave PS executes a check, on the basis of the data from the master PS, as to whether program re-writing is necessary. Although not shown in the Figures, as soon as a slave PS determines that no re-writing is necessary or possible, it causes forced sequence interruption.

A step 320 which is executed as a next step to the step 314, is constituted by steps 304 and 315 to 317. The step 304 is constituted by a phase of progressive transfer of program data to be transferred from the master PS to the slave PSs. In the step 316, reply signals are transmitted from the slave PSs to the master PS or re-transfer request signals are transmitted from the slave PSs to the master SP on the basis of the result of data check executed in the step 315.

Simultaneously with this operation, a step 317 is executed, in which each slave PS executes a check as to whether the transmission of program data to be transferred has been completed. When the result of check is “Yes” (Y), the sequence operation jumps to a step 319, in each slave PS provides a completion display, thus bringing an end to the sequence operation.

The step 320 constituted by the steps 304 and 315 to 317 is repeatedly executed for a period of time until the master PS detects the lapse of a predetermined time in a step 305 (i.e., while the result of check in the step 305 is “No”). When the lapse of the predetermined time is detected (i.e., when the check result becomes “Yes”), an end is brought to the step 320.

Even during the step 320, since one-to-plural communication is in force, each slave PS transmits the transmission signal intermittently.

When the master PS determines in the step 305 that the predetermined time has elapsed, the sequence operation goes to the step 306, in which the master PS transmits an interrupt signal to each slave PS, the transmission is stopped in a step 307 and each slave PS executes a step 318 of call signal retrieval. Meanwhile, in the step 307 the master PS does vacant channel selection. In the next step 308, the master PS transmits a call signal to each slave PS, whereby the interrupted sequence is resumed.

When it is determined in the step 320 that all re-writing data have been received by the slave PSs, a step 319 of completion display is executed, thus completing the sequence operation.

It is also possible to implement the slave PSs such that the number of replied PSs is sent in the step 303 as data such as to restrict the interval of signal transmission from the slave PSs. In this implementation, if the number of replied PSs displayed in the step 303 is provided, the interval of signal transmission to the master PS is determined with reference to the number, and if no replied PS number is displayed, it is determined on the basis of a predetermined numerical value.

A specific example of the transmission interval is (Y×4) bursts where Y is the number of replied PSs. Although not shown in the FIG. 3 sequence, such an implementation is possible that the master PS could have not received any reply signal in the step 312 in a predetermined period of time, an abnormal end is brought by displaying the failure of program transfer.

Each slave PS having received the above data in the step 313 does a check, according to model data and version data, as to the possibility and necessity of program re-writing. Examples of determining the impossibility are failure of model data identity and failure of version-up. Although not shown in the sequence diagram, a slave PS which has decided as the result of check in the step 313 that program re-writing is impossible or unnecessary, displays this content, and brings an end to the sequence.

The step 320 constitutes a data transfer phase, the master PS transmits write data signals one at a time. In the step 304, the master PS transmits signal containing stored addresses and data as the write data signal. In every transmission, the data content is updated sequentially from the forefront of program to be transferred. When the program to be transferred has been fully transmitted the transmission is continued from the forefront again.

In the step 315, each slave PS makes a check, with reference to the content of the write data signal, as to whether it could have received the data with continuous addresses, and stores the addresses concerning the right reception. In the step 316, each slave PS transmits a reply signal or a re-transfer request. When this is “OK”, the slave PS transmits a reply signal in the transmission interval determined in the step 313. In the case of “NG”, the slave PS transmits a re-transfer request signal including address data.

The master PS which has received the re-transfer request signal may be implemented such that it re-transmits or does not re-transmit on the basis of the request. Even in the case of implementation of the master PS such as not to re-transfer, the master PS is adapted such that after transmission of full data to be transmitted it returns to the forefront for repeated transmission. The slave PSs can expect to receive data at the next transmission time.

Subsequently, each slave PS executes the step 317 of checking whether the data corresponding to the addresses obtained in the step 313 have been fully received. When it finds that the data have been fully received, each slave PS executes the step 319 of completion display.

When the master PS has transmitted one pack of write data, it executes the step 305 of checking whether a predetermined time has elapsed. When the time has not been elapsed, the master PS goes back to the step 304 of transmitting the next data. When the time has been elapsed, the master PS executes the steps 306 to 308. The steps 306 to 308 and 318 constitute a process equivalent to operation in case of continuous communication for three minutes in direct communication between PSs as prescribed in the PHS telephone system standards (RCR STD-28).

As has been shown, the master PS continuously transmits write data by repeatedly executing “calling”, “going to communication phase”, “transmission of a plurality of data” and “interruption”. The slave PS repeatedly executes “replying to call”, “going to communication phase”, “reception of a plurality of data” and “interruption” until the write data has been fully received, thus completing updating of program or the like.

Also, unless the operation of the master PS is positively interrupted, the master PS having reached the end of data to be transferred returns to the forefront to continue transmission. The slaves PS are thus adapted that it may receive afterward the data which has been transmitted prior to the start operation.

The steps 306 to 308 and 318 are implemented in order to permit write data accept from the above “interruption” and “call phase” (the transfer is executed in progress) even when the start operation of the slave PS is made after the start of the transfer. This is executed so in order to permit, when start operations of a very large number of slave PSs are to be made, the start operation timings of the slave PSs to be preset as desired.

The step 305 may be implemented such that the time value in it is either a fixed value or can be designated by the start operation of the master PS. While in FIG. 3 the start operations of the slave PS are done collectively (step 310) after the start operation of the master PS (step 301), the same result is obtainable by the converse execution order of the steps 301 and 310.

The first embodiment having been described is constituted by the program transfer source master PS (i.e., master communication unit 101) and program/data re-writing subject slave PS (i.e., slave communication units 110 to 117) and without provision of any special additional wireless communication units. However, the present invention is also applicable to a wireless communication system, in which a plurality of communication end terminals each provided with an additional wireless communication unit can do mutual communication of voice, data, etc. by using such medium as radio waves and light.

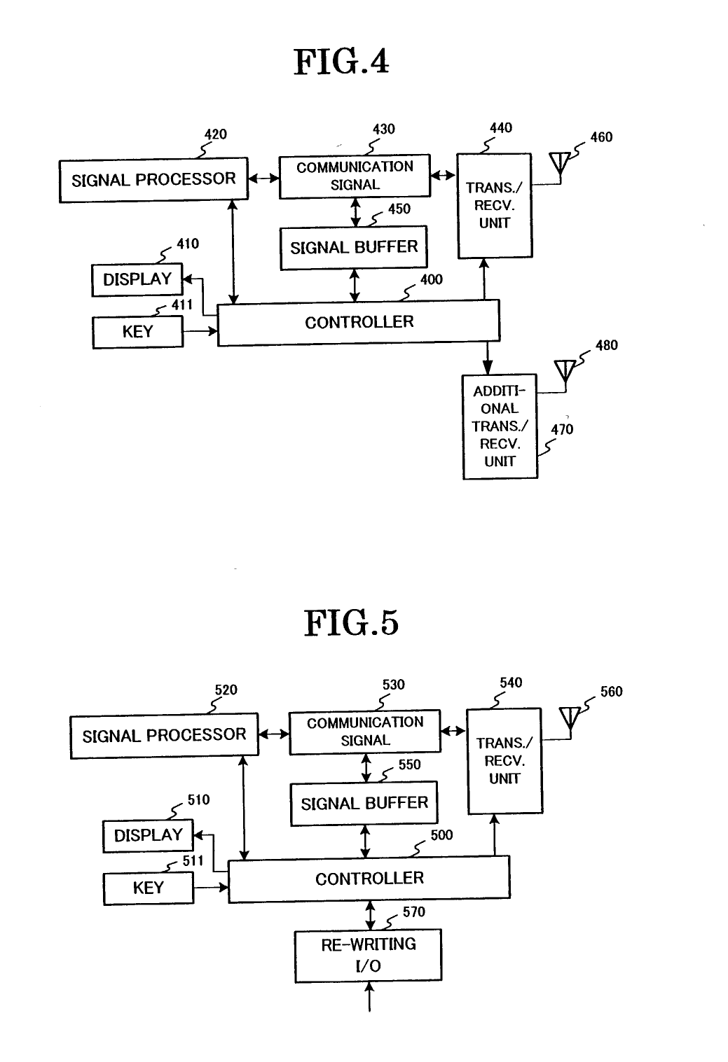

This form of system will now be described as a second embodiment with reference to FIG. 4. The communication unit as shown in FIG. 4, comprises the same circuit members as the controller 200, the display 210, the key operating part 211, the signal processing part 220, the communication signal 230, the transmitting/receiving part 240, the signal buffer 250, the antenna 260 as described before in connection with FIG. 1, i.e., a controller 400, a display 410, a key operating part 411, a signal processing part 420, a communication signal 430, a transmitting/receiving part 440, a signal buffer 450 and an antenna 460, and it further comprises an additional transmitting/receiving part 470 connected to the controller 400.

The transmitting/receiving part 440, like the portable telephone set, is incapable of executing mutual communication with a unit of the same type as intrinsic specifications of communication. On the other hand, the additional transmitting/receiving part 470 is provided with additional wireless communication means called “Bluetooth” for communication with a peripheral unit. This part permits bidirectional wireless communication of data between units of the same type, and a transmission/reception antenna 460 is connected to this part.

Owing to the presence of this additional transmitting/receiving part 470, like the case of the above first embodiment, it is possible to permit simultaneous transfer, for updating, of a software program mounted on the unit without any special unit among a number of units capable of doing mutual wireless communication without any special unit.

While the two embodiments have concerned as example with the wireless communication terminals such as PSs and portable telephone sets. However, the wireless communication terminals are by no means limitative, and the present invention is applicable to all units having additional wireless communication means capable of mutual communication among units of the same type. Also, while the communication medium for transfer has been radio waves in a narrow sense, it is of course also possible to use optical communication means as Ir DA standards or the like.

Changes in construction will occur to those skilled in the art and various apparently different modifications and embodiments may be made without departing from the scope of the present invention. The matter set forth in the foregoing description and accompanying drawings is offered by way of illustration only. It is therefore intended that the foregoing description be regarded as illustrative rather than limiting.

As has been made obvious in the foregoing, with the wireless communication system with data changing/updating function according to the present invention it is possible to permit simultaneous transfer, for updating, of a software program mounted on the unit among a number of units capable of doing mutual wireless communication without any additional unit or works. It is thus possible to greatly reduce necessary time and cost.

It is further possible to obviate the prior art inconvenience that the re-writable place is subject to limitation due to limitations imposed by preparations of the additional unit.

Thus, according to the present invention it is possible to provide a wireless communication system with data changing/updating function, which permits, without need of any exclusive additional unit or special re-writing interface, changing and/or updating of programs, accumulated data, etc. without substantial time and cost even in the case of a system, to which a large number of terminal units are connected.

What is claimed is:

1. A wireless communication system with data changing/updating function for mutual communication of voice, data, etc. among a plurality of mobile terminal units by using radio waves, light or like medium, wherein:
the plurality of mobile terminal units each includes a storing means for storing data concerning the control of the own unit, a transmitting means for reading out data stored in the storing means and transmitting the read-out data to an other unit, a receiving means for receiving control data transmitted from the other unit, and a re-writing means for changing and/or updating control data stored in the storing means in the own unit on the basis of control data received by the receiving means.

2. A wireless communication system with data changing/updating function for mutual communication of voice, data, etc. among a plurality of mobile terminal units by using radio waves, light or like medium, wherein:
a selected unit among the plurality of mobile terminal units includes a storing means for storing data for control of the own unit, and a transmitting means for reading out data stored in the storing means and transmitting the read-out data to an other unity; and
a selected unit among the plurality of mobile terminal units includes a storing means for storing data concerning control of the own unit, a receiving means for receiving control data transmitted from the other unit, and a re-writing means changing and/or updating control data stored in the storing means in the own unit on the basis of control data received by the receiving means.

3. A wireless communication system with data changing/updating function for mutual communication of voice, data, etc. among a plurality of communication terminal units each provided with an additional wireless communication unit by using radio waves, light or like medium, wherein:
the plurality of communication terminal units each includes a storing means for storing data concerning control of the own unit, a transmitting means for reading out data stored in the storing means and transmitting the read-out data to an other unit, a receiving means for receiving control data transmitted from the other unit, and a re-writing means for changing and/or updating control data stored in the storing means in the own unit on the basis of control data received by the receiving means.

4. A wireless communication system with data changing and/or updating function for mutual communication of voice, data, etc. among a plurality of communication terminal units each provided with an additional wireless communication unit by using radio waves, light or like medium, wherein:
a selected unit among the plurality of communication terminal units includes a storing means for storing data for control of the own unit, and a transmitting means for reading out data stored in the storing means and transmitting the read-out data to the other unit; and
a selected unit among the plurality of communication terminal units includes a storing means for storing data for control of the own unit, a receiving means for receiving control data transmitted from the other unit, and a re-writing means for changing and/or updating control data stored in the storing means in the own unit.

5. The wireless communication system with data changing/updating function according to one of claim 1 to 4, wherein at the time of a call signal transmission from a given unit among the plurality of mobile terminal units or the communication terminal units to the plurality of other units, the number of other units with reply signals received therefrom, and when the detected number is identical with the number of transmitted calls, the transmission interval time of the plurality of other units is determined on the basis of the detected number, while determining it according to a predetermined number in the case of failure of detection of any transmitted call number.

6. The wireless communication system with data changing/updating function according to one of claims 1 to 5, wherein the storing means stores a program to be executed by the own unit.

7. The wireless communication system with data changing/updating function according to one of claims 1 to 5, wherein the storing means stores version data of programs to be executed by the own unit.

8. The wireless communication system with data changing/updating function according to one of claims 1 to 5, wherein the storing means stores communication history data of the own unit.

9. The wireless communication system with data changing/updating function according to claim 8, wherein the storing means stores calling history data of the own unit.

10. The wireless communication system with data changing/updating function according to claim 8, wherein the storing means stores called history data.
